(19) United States
(12) Patent Application Publication
(10) Pub. No.: US 2022/0185091 A1
(43) Pub. Date: Jun. 16, 2022

(54) HYBRID MODULE WITH SEPARATING CLUTCH AND ACTUATION UNIT WITHOUT COMPENSATION; AS WELL AS DRIVE TRAIN

(71) Applicant: Schaeffler Technologies AG & Co. KG, Herzogenaurach (DE)

(72) Inventor: Dirk Hofstetter, Durmersheim (DE)

(73) Assignee: Schaeffler Technologies AG & Co. KG, Herzogenaurach (DE)

(21) Appl. No.: 17/432,157

(22) PCT Filed: Sep. 10, 2020
(86) PCT No.: PCT/DE2020/100035

§ 371 Date: Aug. 19, 2021

(30) Foreign Application Priority Data
Mar. 7, 2019 (DE) 10 2019 105789.2

(51) Int. Cl. B60K 6/387; F15B 15/20

(52) U.S. Cl. CPC B60K 6/387; F15B 15/20

(57) ABSTRACT

A hybrid module includes an input shaft, an electric machine having a rotor, a carrier coupled to the rotor, a separating clutch arranged between the input shaft and the carrier, a hydraulic actuating unit for adjusting the separating clutch, a hydraulic pressure chamber, and a restoring spring unit. The separating clutch has friction elements and the hydraulic actuating unit has a sliding element that acts on the friction elements. The restoring spring unit and the hydraulic pressure chamber are designed and coordinated with one another such that, when the hybrid module is operating and the carrier is rotated with a rotational speed of at least 3000 rpm, an axial restoring force applied to a second axial side of the hydraulic actuating unit is greater than an axial adjustment force generated by a centrifugal force in the hydraulic pressure chamber acting on a first axial side of the hydraulic actuating unit.

### CROSS-REFERENCE TO RELATED APPLICATIONS

This application is the United States National Phase of PCT Appln. No. PCT/DE2020/100035 filed Jan. 20, 2020, which claims priority to German Application No. DE102019105789.2 filed Mar. 7, 2019, the entire disclosures of which are incorporated by reference herein.

### TECHNICAL FIELD

The present disclosure relates to a hybrid module for a drive train of a motor vehicle, such as a car, truck, bus, or other utility vehicle, having a housing, an input shaft that can be rotated relative to the housing and connected to an internal combustion engine, an electric machine, a carrier rotationally coupled with a rotor of the electric machine, a separating clutch operatively introduced between the input shaft and the carrier, and a hydraulic actuating unit designed to adjust the separating clutch between a closed position and an open position. The actuating unit has a sliding element which acts on multiple friction elements of the separating clutch and which sliding element, towards the first axial side thereof, encloses a hydraulic pressure chamber with the carrier and towards the second axial side thereof an axial restoring force is applied by a restoring spring unit.

### BACKGROUND

Hybrid modules of the generic type with rotary lead-throughs are known, for example, from WO 2019/015714 A1. In the known rotary lead-throughs, the centrifugal forces acting during operation can lead to pressure fluctuations within the pressure chamber. A compensation chamber is usually used to compensate for these pressure fluctuations caused by centrifugal forces. This compensation chamber, however, occupies a relatively large axial installation space.

### SUMMARY

The present disclosure provides a hybrid module which, despite (mechanical) centrifugal force compensation, has a compact design.

According to the disclosure, the restoring spring unit and the pressure chamber are designed and coordinated with one another in such a way that, when the hybrid module is in operation, with a rotating carrier up to a rotational speed of at least 3000 rpm, the restoring force generated by the restoring spring is greater than an axial adjustment force of the pressure chamber generated by a centrifugal force in the pressure chamber and acting axially opposite to the restoring force acting on the sliding element in the direction of the closed position. The actuation unit is thus designed without a compensation chamber.

The restoring spring unit being so strongly designed means that additional components previously used for moving the compensation chamber can be omitted. This makes the design more compact.

With regard to the design of the restoring spring unit, it has been found to be expedient for use in higher-speed vehicles if the restoring spring unit and the pressure chamber are designed and coordinated in such a way that in operation, with the carrier rotating up to a rotational speed of at least 4000 rpm, 6000 rpm, 8000 rpm, or at least 10000 rpm, the restoring force generated by the restoring spring unit is greater than the axial adjustment force of the pressure chamber generated by the centrifugal force in the pressure chamber.

If the restoring spring unit has multiple spring elements, each of which may be implemented as helical compression springs, a greater restoring force can be generated.

A hydraulic rotary lead-through may be provided in the carrier which is connected to the pressure chamber and further connected to a channel system on the housing side. As a result, the rotary lead-through is designed to save space.

An actuation collar of the sliding element that extends radially outside the pressure chamber may be implemented directly as a pressure pot that interacts with the friction elements of the separating clutch. The sliding element is thus made axially compact.

The sliding element may be formed in one piece from a sheet of metal.

If the sliding element directly has an axially protruding guide collar, which guide collar is slidably guided on a supporting base of the carrier, the construction of the actuating unit is further simplified.

The supporting base is mounted so that it can rotate further relative to the housing by means of a support bearing.

If a first seal sealing the pressure chamber is axially fixed in a recess within the carrier, an even more space-saving arrangement is made possible.

Furthermore, a second seal sealing the pressure chamber may be received on the carrier in a non-displaceable manner.

If, in addition to the separating clutch, there is at least one further clutch axially offset from the separating clutch, it can be further connected to a transmission.

The present disclosure further relates to a drive train for a motor vehicle having a hybrid module according to at least one of the previously described embodiments.

In other words, according to the disclosure, a clutch K0 (separating clutch) with a rotary lead-through is implemented without compensation. To avoid unintentional closing of the separating clutch at increased speed and an associated increase in centrifugal forces in a pressure chamber, a restoring spring (restoring spring unit) of the separating clutch is designed to be particularly strong.

### BRIEF DESCRIPTION OF THE DRAWINGS

In the following, the invention is now explained in more detail with reference to a single FIGURE. The single FIGURE shows a longitudinal sectional illustration of a hybrid module according to the disclosure, designed according to an exemplary embodiment, wherein the intersected components are shown without hatching. The FIGURE is only schematic in nature and thus serves only for understanding the invention.

### DETAILED DESCRIPTION

The single FIGURE illustrates an exemplary embodiment of a hybrid module 1 according to the present disclosure. The hybrid module 1 is typically implemented as a combined structural unit comprising an electric machine 5 (for the sake of clarity only shown on the part of the rotor 6 thereof) and at least one, here even three clutches 8, 25a, 25b. The hybrid module 1 is arranged during operation in a drive train 2 of a motor vehicle, indicated in principle in the FIGURE. In particular, the hybrid module 1, viewed along a central axis of rotation 28, is inserted between an output shaft of an internal combustion engine and multiple transmission input shafts of a transmission. The presence of the electric machine 5 means that the hybrid module 1 is used to implement the hybrid drive train 2.

The hybrid module 1 has an input shaft 4. The input shaft 4 is non-rotatably connected to the output shaft of the internal combustion engine during operation. The input shaft 4 is mounted so that it can rotate relative to a partially illustrated housing 3 of the hybrid module 1. The input shaft 4 penetrates the housing 3 and protrudes into an interior of the hybrid module 1/housing 3. In a region arranged within the hybrid module 1, the input shaft 4 is connected to a separating clutch 8. The separating clutch 8, which is implemented here as a multi-plate clutch, namely a friction multi-plate clutch, has a first clutch component 29a, which is non-rotatably connected to the input shaft 4. For this purpose, a pot-like plate carrier 30 of the separating clutch 8 is fastened non-rotatably directly to the input shaft 4. The first clutch component 29a of the separating clutch 8 has, in addition to the plate carrier 30, multiple first friction elements 10a which are held on the plate carrier 30 non-rotatably but in an axially displaceable manner relative to one another.

A second coupling component 29b of the separating clutch 8, which can optionally be connected to the first coupling component 29a, is received on a central carrier 7, which is mounted so that it can rotate relative to the housing 3. The carrier 7 forms a sleeve-shaped torque transmission region 31, on the radial outer side 32 of which the rotor 6 of the electric machine 5 is directly received. The torque transmission region 31 has an internal toothing 33, which internal toothing 33 directly forms the second clutch component 29b. Multiple second friction elements 10b of the separating clutch 8 are received directly on the internal toothing 33 non-rotatably and in an axially displaceable manner relative to one another.

The first friction elements 10a and the second friction elements 10b of the separating clutch 8 are arranged alternately to one another in a typical manner in the axial direction. Consequently, the first friction elements 10a and the second friction elements 10b are arranged axially at the same height as the torque transmission region 31/rotor 6 and radially within the torque transmission region 31. In an open position of the separating clutch 8, the friction elements 10a, 10b are rotationally decoupled from one another; in a closed position of the separating clutch 8, the friction elements 10a, 10b are pressed against one another with a frictional connection.

To actuate the separating clutch 8 between the open position thereof and the closed position thereof, a hydraulic actuation unit 9 is provided, which is implemented according to the embodiment according to the present disclosure. The actuation unit 9 is equipped with a sliding element 11. The sliding element 11 is received directly on the carrier 7 and is thus non-rotatably coupled thereto. The sliding element 11 is formed in one piece from a metal sheet. The sliding element 11 forms a piston region 34 on a radial inside, which piston region 34 is guided in a receiving space 35 of the carrier 7, forming a sealed hydraulic pressure chamber 13. The receiving space 35 is implemented, for example, as an annular circumferential recess. On the first axial side 12a thereof, the sliding element 11 faces the region of the carrier 7 that forms the receiving space 35 and encloses the pressure chamber 13 therewith. On a second axial side 12b facing away from the first axial side 12a, a restoring spring unit 14 acts directly on the sliding element 11. This restoring spring unit 14, which is firmly supported relative to the carrier 7, applied to the sliding element 11 against a compressive force/actuating force/adjusting force generated in the pressure chamber 13.

The sliding element 11 has an axially protruding guide collar 19 on a radial inside of the piston region 34. The guide collar 19 is guided directly on a supporting base 21 of the carrier 7, which likewise extends in the axial direction. The supporting base 21 is in turn mounted relative to the housing 3 by means of a support bearing 27, implemented here in the form of a roller bearing, namely a ball bearing. The supporting base 21 is penetrated by a radial connecting channel 36, which connects directly to a hydraulic channel system 16 of the housing 3 and together therewith forms a rotary lead-through 17. Via the channel system 16 and the rotary lead-through 17 together with the connecting channel 36, a hydraulic medium can consequently be fed to the pressure chamber 13 or removed therefrom to adjust the separating clutch 8.

In the FIGURE, an open position of the separating clutch 8 is implemented. To close the separating clutch 8, hydraulic pressure is applied to the pressure chamber 13 and as soon as this pressure exceeds a restoring force generated by the restoring spring unit 14, the sliding element 11 is displaced in such a way that it presses the friction elements 10a, 10b against one another in a frictional-fit manner.

As can also be seen, the sliding element 11 is equipped with an actuation collar 18, which also protrudes axially, radially outside the piston region 34 and the pressure chamber 13. The actuation collar 18 serves directly as a pressure pot and, in this embodiment, has an adjusting effect on a second friction element 10b of the separating clutch 8 arranged at the end. This second friction element 10b arranged at the end is also referred to as a pressure plate.

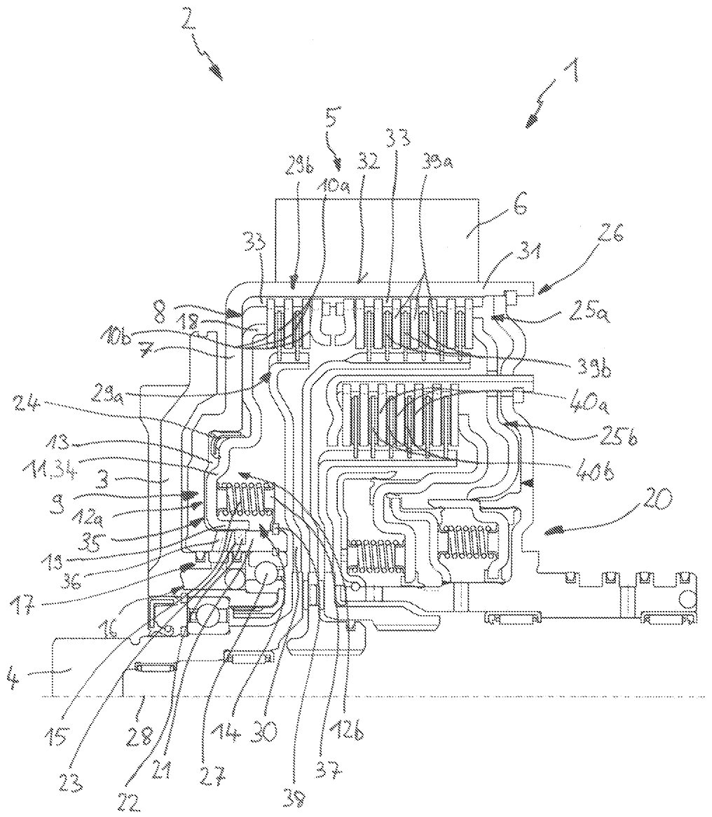

According to the present disclosure, the restoring spring unit 14 and the pressure chamber 13 are designed and coordinated with one another in such a way that when the hybrid module 1 is in operation, with a rotating carrier 7 at a rotational speed up to 10,000 rpm, the restoring force generated by the restoring spring unit 14 is greater than an axial adjustment force of the pressure chamber 13 generated by a centrifugal force in the pressure chamber 13, axially opposite to the restoring force acting on the sliding element 11. Below a rotational speed of 10,000 rpm and when there is no additional pressurization of the pressure chamber 13 with hydraulic pressure, the sliding element 11 thus remains in a position corresponding to the open position/rest position of the separating clutch 8, as shown in FIG. 1. The second axial side 12b can thus be implemented without a compensation chamber. There is thus no compensation chamber implemented in the entire actuation unit 9.

The restoring spring unit 14 is shown in FIG. 1 only on the part of a spring element 15 in the form of a helical compression spring. In principle, according to further embodiments, the restoring spring unit 14 may haves multiple spring elements 15. These multiple spring elements 15 may be arranged in a distributed manner in the circumferential direction. However, multiple spring elements 15 may be combined in a common spring assembly and, for example, a first spring element designed as a helical compression spring may be arranged within a further second spring element, also designed as a helical compression spring.

The formation of a plate spring as the spring element 15 is also implemented in further embodiments according to the present disclosure. According to the FIGURE, the spring element 15 is supported at the first end thereof on the sliding elements 11 and at the second end thereof axially fixed on the carrier 7, namely on the supporting base 21. For this purpose, a centering element 37, which is firmly supported on the carrier 7, is supported via a securing ring 38, which is received directly on the carrier 7.

To seal the pressure chamber 13, a first seal 22 is axially fixed in a recess 23 of the supporting base 21 in the carrier 7, namely in the supporting base 21. This first seal 22 serves to seal a first radial gap, between the supporting base 21 and the guide collar 19, from a radial inside of the pressure chamber 13. A further second seal 24 is applied directly to the sliding element 11 in this embodiment. This second seal 24 serves to seal a second radial gap between the carrier 7 and the sliding element 11, towards a radial outside of the pressure chamber 13.

In addition to the separating clutch 8, two clutches 25a, 25b, each forming a partial clutch of a double clutch 26, are provided in the hybrid module 1 so that the hybrid module 1 as a whole has a triple clutch. The two partial clutches 25a, 25b are each inserted between the carrier 7 and a transmission input shaft of a transmission, not shown here for the sake of clarity. The first partial clutch 25a is operatively introduced between the carrier 7 and a first transmission input shaft and the second partial clutch 25b between the carrier 7 and a second transmission input shaft.

It should also be noted here that the separating clutch 8 with the friction elements 10a, 10b thereof is arranged in the radial direction at the same height as multiple friction elements 39a, 39b of the first partial clutch 25a. The first and second friction elements 39a, 39b of the first partial clutch 25a are also arranged in the axial direction at the same height as the rotor 6/torque transmission region 31.

Multiple friction elements 40a, 40b of the second partial clutch 25b are arranged radially within the friction elements 39a, 39b of the first partial clutch 25a and the friction elements 10a, 10b of the separating clutch 8. The first and second friction elements 40a, 40b of the second partial clutch 25b are also arranged in the axial direction at the same height as the rotor 6. The structure of the first and second partial clutches 25a, 25b corresponds to the usual structure of a friction multi-plate clutch, as it is already implemented by the separating clutch 8.

The partial clutches 25a, 25b are actuated via a further clutch actuation system 20, which in turn has a subunit for each partial clutch 25a, 25b. The clutch actuation system 20 is arranged at least partially radially inside the friction elements 40a, 40b of the second partial clutch 25b.

In other words, according to the present disclosure, a possibility is given to reduce the axial installation space and to dispense with a separate rotational speed compensation of the clutch K0 (separating clutch 8). As a countermeasure, a restoring spring (restoring spring unit 14) is designed to be particularly strong.

The usual, previously implemented compensation with compensation chamber works as follows: The clutch K0 is actuated via a pressure pot (sliding element 11). The required force is generated by oil pressure in the pressure chamber 13. The oil pressure is provided by the transmission hydraulics. A restoring spring 14 has the effect that the pressure pot 11 does not move until a certain oil pressure is reached and the clutch 8 closes. When the clutch 8 begins to rotate, the oil in the pressure chamber 13 also rotates. The centrifugal forces acting here generate what is known as centrifugal oil pressure in the pressure chamber 13, which also acts on the pressure pot 11. If this centrifugal oil pressure is greater than the restoring force of the restoring spring 14, the clutch 8 begins to close without this being intended. To prevent this, the compensation chamber/compensation space has hitherto been located on the rear side 12b of the pressure pot 11. The compensation chamber is limited by a seal carrier. The compensation space is filled with unpressurized oil. When the clutch 8 rotates, the centrifugal oil pressures that arise in the compensation chamber counteract the centrifugal oil pressures that arise in the pressure chamber 13, and the forces that act on the pressure pot 11 are fully or at least partially compensated. This has the effect that the pressure pot 11 does not begin to move at all or only begins to move at significantly higher rotational speeds.

According to the present disclosure, a separate centrifugal oil compensation is omitted. In other words, the previous seal carrier and thus the entire compensation space are omitted; there is also no need to supply oil to the compensation chamber. The omission of these elements leads to a reduction in the axial space requirement. The actuation of the clutch K0 remains as described above after the embodiment according to the invention. According to the disclosure, the restoring springs 15 are specifically reinforced and thus the restoring spring force is greater than the force resulting from the centrifugal oil pressure in the pressure chamber 13. Or, the number of restoring springs 15 is increased so that the restoring spring force is also greater than the force resulting from the centrifugal oil pressure in the pressure chamber 13.

### REFERENCE NUMERALS

1 Hybrid module
2 Drive train
3 Housing
4 Input shaft
5 Electric machine
6 Rotor
7 Carrier
8 Separating clutch
9 Actuation unit
10a First friction element of the separating clutch
10b Second friction element of the separating clutch
11 Sliding element
12a First side
12b Second side
13 Pressure chamber
14 Restoring spring unit
15 Spring element
16 Channel system
17 Rotary lead-through
18 Actuation collar
19 Guide collar
20 Clutch-actuation system
21 Supporting base
22 First seal
23 Recess
24 Second seal
25a First partial clutch
25b Second partial clutch
26 Double clutch
27 Support bearing
28 Axis of rotation
29a First clutch component of the separating clutch
29b Second clutch component of the separating clutch
30 Plate carrier
31 Torque transmission region
32 Outer side
33 Internal toothing
34 Piston region
35 Receiving space
36 Connection channel
37 Centering element
38 Securing ring
39a First friction element of the first partial clutch
39b Second friction element of the first partial clutch
40a First friction element of the second partial clutch
40b Second friction element of the second partial clutch

1.-10. (canceled)

11. A hybrid module for a drive train of a motor vehicle, comprising:
a housing;
an input shaft rotatable relative to the housing and arranged for connection to an internal combustion engine;
an electric machine comprising a rotor;
a carrier rotationally coupled to the rotor;
a separating clutch operatively arranged between the input shaft and the carrier, the separating clutch comprising a plurality of friction elements;
a hydraulic actuating unit arranged to adjust the separating clutch between a closed position and an open position, the hydraulic actuating unit comprising a sliding element arranged to act on the plurality of friction elements;
a hydraulic pressure chamber at least partially enclosed by the carrier and a first axial side of the sliding element; and
a restoring spring unit arranged to apply an axial restoring force to a second axial side of the hydraulic actuating unit, wherein the restoring spring unit and the hydraulic pressure chamber are designed and coordinated with one another such that, when the hybrid module is operating and the carrier is rotated with a rotational speed of at least 3000 rpm, the axial restoring force is greater than an axial adjustment force generated by a centrifugal force in the hydraulic pressure chamber acting on the first axial side.

12. The hybrid module of claim 11, wherein the restoring spring unit and the hydraulic pressure chamber are designed and coordinated with one another such that, when the hybrid module is operating and the carrier is rotated with a rotational speed of at least 4000 rpm, the axial restoring force is greater than the axial adjustment force generated by the centrifugal force in the hydraulic pressure chamber acting on the first axial side.

13. The hybrid module of claim 11, wherein the restoring spring unit and the hydraulic pressure chamber are designed and coordinated with one another such that, when the hybrid module is operating and the carrier is rotated with a rotational speed of at least 6000 rpm, the axial restoring force is greater than the axial adjustment force generated by the centrifugal force in the hydraulic pressure chamber acting on the first axial side.

14. The hybrid module of claim 11, wherein the restoring spring unit and the hydraulic pressure chamber are designed and coordinated with one another such that, when the hybrid module is operating and the carrier is rotated with a rotational speed of at least 8000 rpm, the axial restoring force is greater than the axial adjustment force generated by the centrifugal force in the hydraulic pressure chamber acting on the first axial side.

15. The hybrid module of claim 11, wherein the restoring spring unit and the hydraulic pressure chamber are designed and coordinated with one another such that, when the hybrid module is operating and the carrier is rotated with a rotational speed of at least 10,000 rpm, the axial restoring force is greater than the axial adjustment force generated by the centrifugal force in the hydraulic pressure chamber acting on the first axial side.

16. The hybrid module of claim 11 wherein the restoring spring unit comprises multiple spring elements.

17. The hybrid module of claim 11 wherein:
the housing comprises a channel system; and
the carrier comprises a hydraulic rotary lead-through hydraulically connected to the hydraulic pressure chamber and to the channel system.

18. The hybrid module of claim 11 wherein:
the sliding element comprises an actuation collar;
the actuation collar extends radially outside of the hydraulic pressure chamber; and
the actuation collar is a pressure pot that operates on the plurality of friction elements.

19. The hybrid module of claim 11 wherein:
the carrier comprises a supporting base; and
the sliding element comprises an axially protruding guide collar slidably guided on the supporting base.

20. The hybrid module of claim 11 further comprising a first seal for sealing the hydraulic pressure chamber, wherein the carrier comprises a recess and the first seal is axially fixed in the recess.

21. The hybrid module of claim 11 further comprising a second seal for sealing the hydraulic pressure chamber, the second seal being received on the carrier in a non-displaceable manner.

22. The hybrid module of claim 11 further comprising an additional clutch axially offset from the separating clutch.

23. A drive train for a motor vehicle comprising the hybrid module of claim 11.
